(19) United States
(12) Patent Application Publication
(10) Pub. No.: US 2008/0206460 A1
(43) Pub. Date: Aug. 28, 2008

(54) Method of producing metal substructures for dental restorations

(76) Inventors: Lawrence J. Rhoades, Naples, FL (US); John Y.P. Rhoades, Pittsburgh, PA (US)

Correspondence Address: IP & INTERNET LAW NORTH, LLC, P.O. BOX 38, ZELIENOPLE, PA, 16063, US

(21) Appl. No.: 12/069,964

(22) Filed: Feb. 14, 2008

Related U.S. Application Data
(60) Provisional application No. 60/901,924, filed on Feb. 16, 2007.

(51) Int. Cl. B05D 3/02

(52) U.S. Cl. 427/192; 427/191

(57) ABSTRACT

Methods are disclosed for forming a metal substructure that will subsequently be overcoated with ceramic layers to create a dental restoration. The methods involve the steps of providing a metal powder and applying the metal powder to a die and sintering the metal powder to form a solid structure that may be used as a coping. The application of the metal powder is done in a controlled fashion while minimizing the amount of necessary handwork. These application methods include: (a) alternatingly applying an adhesive and a metal powder to the selected portion of the die surface; and (b) forming the metal powder into a viscous slurry or slip and then dipping the die therein or spraying or pouring the slurry or slip onto the selected portion of the die surface.

### CROSS-REFERENCE TO RELATED APPLICATIONS

This application claims priority to U.S. Provisional Application No. 60/901,924, filed Feb. 16, 2007, which is incorporated herein in its entirety.

### FIELD OF THE INVENTION

The present invention relates to the field of the preparation of metal substructures, such as copings, for dental restorations.

### BACKGROUND OF THE INVENTION

Typically, methods for the fabrication of the metal substructures, such as copings, for dental restorations involve the use of highly skilled technicians for extensive amounts of time, resulting in a fairly high overall cost to patients. The final dental restoration is achieved by adding layers of ceramic coatings to the metal substructure to achieve suitably hard outer surface having the appearance of a natural tooth.

Traditionally, the metal substructure is made by the lost wax process, in which a metal substructure is made by casting a molten metal into a casting mold that was formed from a wax pattern that was in turn made from a ceramic casting which was made from a wax impression of the patient's prepared teeth. This traditional process produces excellent results, but takes a long time and involves a large amount of waste of the casting metal, which is often a precious metal, in the form of sprues and runners which must be repurified before reuse is possible.

Efforts have been made to automate the process, for example, by the use of three-dimensional printing systems. However, although such systems reduce the waste and time involved in making a metal substructure and demonstrate excellent dimensional exactness and quality, these systems involve significant capital expenditures for the necessary specialized equipment.

Other approaches have been developed for making metal substructures using foils, metal powder pastes, and metal powder tapes. Some of these approaches are described in the following patents and patent applications, all of which are hereby incorporated by reference: EP 0 523 019 A2 of Nobil Metals S.r.1.; FR 2 660 224 A1 of Seguri; U.S. Pat. Nos. 3,502,466 to Vikery, 4,369,068 to Hausselt et al., 4,434,211 to Shoher et al., 4,661,071 to Bell et al., 4,689,197 to Groll et al., 4,814,008 to Shoher et al., 4,828,495 to Bell et al., Re. 33,371 to Shoher et al., 4,980,124 to Dimmer, 4,990,394 to Shoher et al., 5,234,343 to Shoher et al., 5,362,438 to van der Zel, 5,332,622 to Shoher et al., Re. 35,367 to Shoher et al., 5,730,600 to Shoher et al., 5,909,612 to van der Zel, 6,027,012 to Bes et al., 6,325,839 B1 to Prasad et al., 6,667,112 B2 to Prasad et al., and US 2005/0019200 A1 of Venturini et al. However, the prior art methods require fitting the foils or metal tapes by hand to a die, i.e., a replica of the prepared tooth or teeth, or applying and forming the metal powder pastes by way of a spatula or similar handheld instrument, or applying separate layers of a base metal and a sintering aid. What is needed in the art is a method that requires little in initial investment, yet reduces the amount of handwork that is involved with the prior art methods.

### SUMMARY OF THE INVENTION

The present invention provides methods for making metal substructures for dental restorations that fulfill this need. For sake of convenience and brevity, the term “coping” is used hereinafter and in the appended claims to refer to all types of metal substructures which are used as the foundation for ceramic overlays to form a dental restoration. Also for convenience and brevity, the term “die” is used hereinafter and in the appended claims to refer to all types of replicas of a preparation to which the dental restoration is to be fitted.

In its broadest form, the methods of the present invention involve the steps of providing a metal powder and applying the metal powder to a die and sintering the metal powder to form a solid structure that may be used as a coping. In some embodiments of the present invention, the solid structure is infiltrated with a metal to improve the density of the metal coping.

Some embodiments of the present invention involve the application of the metal powder by alternating the deposition of one or more layers of an adhesive onto the die with the deposition of one or more layers of metal powder until the desired coating thickness is achieved. In other embodiments of the present invention, the metal powder and a fugitive vehicle and/or binder are formed into a viscous slurry or slip and then the die is dipped into the slurry or slip one or more times, with optional intervening drying steps, until the desired coating thickness is achieved.

The present invention also optionally includes steps to trim the coating and to enhance the release of the coping from the die. The methods of the present invention may be used to form copings one at a time or to form a plurality of copings at once.

### DESCRIPTION OF PREFERRED EMBODIMENTS

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims.

It is to be understood that for the sake of convenience and brevity, the following description will be presented in terms of the preparation of a single coping. However, it is also to be understood, that the invention also includes the simultaneous or near-simultaneous application of the described procedures to a plurality of copings, e.g., by processing the plurality as a batch or in a partially seriatim/partially batch fashion.

The various embodiments of the present invention create a metal coping by applying a metal powder to a die in a controlled fashion while minimizing the amount of necessary handwork. The metal powder may be in the form of elemental metals, metal alloys, and combinations thereof. For example, in some embodiments, the metal powder comprises a single metal alloy. In others, the metal powder comprises a mixture of the powders of two or more metal alloys. In some embodiments, the metal powder comprises a single elemental metal powder, while in some other it comprises a mixture of the powders of two or more elemental metal powders. In still other embodiments of the present invention, the metal powder comprises a mixture of the powders of one or more metal alloys and of one or more elemental metal powders. The metals and metal alloys that may be used are those which have been approved by the relevant regulatory agency for use in dental applications, e.g., the U.S. Food and Drug Administration, and those metals and/or alloys which, when used in combination, together or with the addition of an optional infiltrant form an overall composition having such regulatory approval. Preferably, the metal powder is selected from one or more of gold, platinum, silver, and alloys thereof whereby the alloys comprise one or more of the metal in combination with one another and/or with a different metal, such as copper, rhodium, palladium, indium, tin, gallium, germanium, cobalt, chromium, iron, and mixtures thereof.

The present invention also contemplates the addition of the powders of intermetallic compounds, and of non-metal elements, e.g., carbon, and compounds, e.g., oxides, carbides, silicides, to the extent that such additions enhance a desired property of the coping or protect the metal powder from oxidation during heat treatment, e.g., where the additional powder includes a flux.

In the preferred embodiments of the present invention, the metal powder may be of a mono-modal or multi-modal distribution. More preferred embodiments utilize a multi-modal distribution which promotes a relatively high packing density for the metal powder. Preferably, the particle size of the metal powder is within the range of about 0.1 to about 150 microns, and more preferably within the range of about 0.1 to about 40 microns.

The applied metal powder thickness will depend on factors such as the structural strength required for the coping, the type of metal powder that is being used, and the amount of shrinkage that is expected prior to and during sintering. Preferably, the thickness is in the range of between about 0.1 to about 1.0 mm, and more preferably in the range of about 0.1 to about 0.4 mm.

The present invention may be practiced with any kind of die material known in the art. However, it will be apparent to persons skilled in the art, that for some embodiments, some die materials are preferred over others. For example, in those embodiments in which the coping is to be sintered upon the die, a refractory die material is preferred. Similarly, due to the lower cost, in embodiments where the coping is to be removed from the die prior to sintering, non-refractory die materials are preferred.

In some embodiments of the present invention, the metal powder is applied to the coping in conjunction with a separately applied adhesive. In such embodiments, the adhesive is applied to the die to provide an interface surface to which the metal powder will adhere. The adhesive-coated surface of the die is then exposed to the metal powder in a manner which results in the powder adhering to and covering the adhesive-coated surface. Some preferred methods of exposure include showering, sprinkling, and spraying the metal powder onto the adhesive-coated surface of the die. A particularly preferred method of exposure is to introduce at least the adhesive coated surface portion of the die into a bed or chamber in which the metal powder has been excited into a fluidized state, e.g., in a fluidized bed. A variant of this preferred method is to first introduce at least the adhesive-coated surface portion of the die into a chamber containing metal powder and then fluidizing the metal powder.

The sequence of adhesive application/metal powder application may be repeated as many times as is necessary to acquire the desired coating thickness. If drying or curing, e.g. by exposure to heat and/or infrared, optical range, ultraviolet, or other radiation, is desired, it may be conducted either after each adhesive/metal powder application cycle, or it may be conducted after two or more, or all of the cycles have been completed.

The adhesive may be applied by brush, spraying, dipping, or any other way that is suitable for the particular adhesive. Preferably, the adhesive is applied as an atomized mist. In practicing these embodiments of the present invention, the selection of the adhesive will depend on many factors, such as the die surface that is to be covered, the metal powder that is to be used, and the curing equipment that is available. Examples of some adhesives that may be used with these embodiments of the present invention include one-part acrylics, epoxies, and urethanes. Liquid solvents in which the adhesive is soluble may be used to make the adhesive easier to apply. Similarly, agents which thicken the adhesive may be used where thickening the adhesive facilitates its application, e.g., by applying by brush.

It is preferred that prior to the application of the adhesive to the die, that the portions of the die below the margin be coated with a maskant to which neither the adhesive nor the metal powder will adhere. Suitable maskants include paraffins, varnishes, and silicones. It is also preferred that prior to the application of the adhesive to the die, the portions of the die at and above the margin be coated with a release agent. The purpose of the release agent is to facilitate the removal of the coping from the die, in some cases before sintering, and, in other cases, after sintering. Suitable release agents include phenolics, polyvinyl acetate, and polytetraflouroethylene.

Some other embodiments of the present invention include mixing the metal powder together with a fugitive vehicle and/or binder into a viscous slurry or slip. The slurry or slip is then applied to the die to form a coating of a desired thickness on the desired portion of the die, which is preferably the portion that extends from the margin to the top of the die. Preferably, the application is accomplished by dipping the die into the slurry or slip. The coating may also be applied by spraying or pouring the slip or slurry onto the die. In any case, it is preferred that the portion of the die that is not to be coated, e.g., the portion below the margin, be masked as described above. A release agent, also as described above, may be utilized to assist in the removal of the coping from the die. The coating may be applied in a single application or in multiple applications, depending on the coating thickness desired, the viscosity of the slurry or slip, and volatility of the vehicle and/or binder. It is preferred that the viscosity of the slurry or slip be adjusted so that a substantially uniform coating thickness is achieved with each application with little or no running. If drying or curing, e.g. by exposure to heat and/or infrared, optical range, ultraviolet, or other radiation, is desired, it may be conducted either after each application, or it may be conducted after two or more, or all of the applications have been completed. In embodiments of the present invention in which a slip is used, it is preferred that the die material and the slip vehicle be matched so that the vehicle is readily absorbed by the die material, because such absorption results in a dense packing of the metal powder particles on the die surface.

Regardless of which of the aforementioned methods of applying the metal powder is used in practicing the present invention, the metal powder is to be sintered together. In some embodiments of the present invention wherein the binder used provides sufficient strength and the die dimensions are such that they accommodate any expected shrinkage of the nascent coping, the nascent coping may be removed from the die prior to sintering and supported during sintering by a suitable, preferably inert, medium, e.g., refractory sand, during the sintering treatment. In other embodiments of the present invention, the metal powder is sintered upon the die. The temperatures, heating rates, hold times, and atmospheres for the sintering treatment are chosen according to the metal powder that is used. A step may be included prior to or during the sintering heating cycle to remove the adhesive, volatile vehicle, or binder, e.g., through evaporation, decomposition, or chemical reaction.

The present invention contemplates in some of its embodiments the application of a refractory coating over the metal powder coating prior to the sintering treatment. Such coatings may help to make the sintering more uniform and avoid distortions that may result from uneven heating. Examples of some suitable refractory coatings and the steps for their application and removal may be found in the aforementioned U.S. Pat. No. 6,667,112 B2, US 2005/0019200 A1, and US 2005/0023710 A1.

In some embodiments of the present invention, sintering alone provides the coping with the physical properties, e.g., strength and density, required for the dental replacement. In other embodiments of the present invention, an infiltration step is performed on the as-sintered coping to enhance its physical properties. The infiltrant is chosen to be a metal or metal alloy that becomes a flowable liquid at a temperature below the temperature at which the as-sintered coping softens sufficiently to suffer dimensional distortion. It is also chosen to be one that sufficiently wets the as-sintered coping so as to be drawn into the open porosity of the as-sintered coping by capillary action and is of a composition that in combination with that of the metal powder forms an overall composition having the regulatory approval described above. The infiltrant may be introduced into the as-sintered coping by any of the conventional wicking methods known in the art of metal infiltration. It may also be applied as a coating using any of the aforementioned steps described for the applying a coating of the metal powder. It may also be applied as a paste in the manner described in the aforementioned U.S. Pat. No. 5,909,612, or as a tape in the manner described in the aforementioned U.S. Pat. No. 5,730,600. In those embodiments wherein the infiltrant is applied as a coating, it may be necessary to include a step to remove the adhesive volatile vehicle and/or binder which was used with the powdered infiltrant to form the coating. Such a step may be carried out either prior to or during the infiltration heat cycle.

In some cases it may be desirable to perform some trimming or mechanical shaping of the applied metal powder coating. This may be done at various points during the process, depending on what is expeditious or convenient. For example, in some cases, excess coating may be wiped away shortly after application. Trimming or mechanical shaping may be done prior to and/or after sintering and/or after infiltration.

After the coping has been prepared by any of the aforementioned methods, it is then ready for further processing by conventional methods, e.g., by the application of layers of ceramic, to complete the dental restoration.

While only a few embodiments of the present invention have been shown and described, it will be obvious to those skilled in the art that many changes and modifications may be made thereunto without departing from the spirit and scope of the invention as described in the following claims.

What is claimed is:

1. A method for making a coping for a dental restoration comprising the steps of:
a) providing a die having an outer surface;
b) providing a slip, said slip including a metal powder, said metal powder including at least one selected from the group consisting of gold, platinum, silver, and their alloys;
c) forming a coating on at least a portion of the outer surface of said die, wherein said forming includes applying said slip to the outer surface of said die by doing at least one selected from the group consisting of (1) dipping at least a part the outer surface of said die into said slip, (2) spraying said slip onto at least a part the outer surface of said die, and (3) pouring said slip onto at least a part of the outer surface of said die; and
d) sintering together said metal powder of said coating into a coping.

2. The method of claim 1, further comprising the step of infiltrating said coping with a second metal, said second metal being in either elemental or alloy form.

3. The method of claim 1, further comprising the step of applying a refractory coating to said coating prior to performing said step (d), wherein said refractory coating improves the uniformity of the sintering together of said metal powder during said step (d).

4. The method of claim 1, further comprising the step of coating at least a second portion of the outer surface of said die that is below the margin with a maskant.

5. The method of claim 4, wherein said maskant is selected from the group consisting of a paraffin, a varnish, and a silicone.

6. The method of claim 1, further comprising the step of applying a release agent to at least a third portion of the outer surface of said die prior to performing step (c), wherein said release agent is selected from the group consisting of a phenolic, polyvinyl acetate, and polytetraflouroethylene.

7. The method of claim 1, further comprising the step of drying or curing said coating prior to performing step (d).

8. The method of claim 1, wherein said metal powder further includes at least one selected from the group consisting of copper, rhodium, palladium, indium, tin, gallium, germanium, cobalt, chromium, and iron.

9. A method for making a coping for a dental restoration comprising the steps of:
a) providing a die having an outer surface;
b) providing a metal powder, said metal powder including at least one selected from the group consisting of gold, platinum, silver, and their alloys;
c) providing an adhesive, said adhesive being capable of adhering to the outer surface of said die and to said metal powder;
d) applying said adhesive to at least a portion of the outer surface of said die to form an adhesive layer thereon;
e) forming a coating on said portion of the outer surface of said die, wherein said forming includes applying said metal powder to said adhesive layer by exposing said portion to a fluidized bed of said metal powder; and
f) sintering together said metal powder of said coating into a coping.

10. The method of claim 9, wherein said adhesive is applied as an atomized mist in step (d).

11. The method of claim 9, further comprising the step of infiltrating said coping with a second metal, said second metal being in either elemental or alloy form.

12. The method of claim 9, further comprising the step of applying a refractory coating to said coating prior to performing said step (f), wherein said refractory coating improves the uniformity of the sintering together of said metal powder during said step (f).

13. The method of claim 9, further comprising the step of coating at least a second portion of the outer surface of said die that is below the margin with a maskant.

14. The method of claim 13, wherein said maskant is selected from the group consisting of a paraffin, a varnish, and a silicone.

15. The method of claim 9, further comprising the step of applying a release agent to at least a third portion of the outer surface of said die prior to performing step (d), wherein said release agent is selected from the group consisting of a phenolic, polyvinyl acetate, and polytetraflouroethylene.

16. The method of claim 9, further comprising the step of drying or curing said coating prior to performing step (f).

17. The method of claim 9, wherein said metal powder further includes at least one selected from the group consisting of copper, rhodium, palladium, indium, tin, gallium, germanium, cobalt, chromium, and iron.
